(19) United States
(12) Patent Application Publication
(10) Pub. No.: US 2007/0115509 A1
(43) Pub. Date: May 24, 2007

(54) CONTROL CIRCUIT AND IMAGE FORMING APPARATUS CONTROLLED BY SOFTWARE AND HARDWARE

(76) Inventor: Tadashi Shinohara, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/557,289

(22) Filed: Nov. 7, 2006

(30) Foreign Application Priority Data
Nov. 7, 2005 (JP) 2005-322792

(51) Int. Cl. G06K 9/32

(52) U.S. Cl. 358/3.26; 382/294; 358/448

(57) ABSTRACT

An image forming apparatus includes a conveyance member having first and second type patterns thereon. The first and second type patterns are a different shape from the other. First and second pattern detection devices are provided to detect the first and second type patterns and output first and second analog signals, respectively. First and second A/D conversion devices are provided to convert the first and second analog signals into first and second digital signals, respectively. A first calculation execution device is provided to execute a first calculation for controlling the image forming apparatus using the first digital signal. A second calculation execution device is provided to execute a second calculation for controlling the image forming apparatus using the second digital signal. The first calculation execution device is realized by software while the second calculation operation execution device is realized by a hardware circuit.

### CROSS REFERENCE TO RELATED APPLICATION

This application claims priority under 35 USC §119 to Japanese Patent Application No. 2005-322792, filed on Nov. 7, 2005, the entire contents of which are herein incorporated by reference.

### BACKGROUND OF THE INVENTION

1. Field of the Invention

The present invention relates to image forming apparatuses and control circuits used in the image forming apparatus.

2. Discussion of the Background Art

Conventionally, an image forming apparatus is sometimes controlled by using and detecting control use patterns formed on a conveyance member that conveys a medium, such as a sheet, etc.

Specifically, latent images for control use patterns are formed on a photoconductive member by charging and exposing thereof. The latent images are then developed by attracting toner thereto. The developed image is then transferred onto a conveyance member, thereby the control use patterns are visualized thereon. That is, processes starting from charging to developing are the same as processes of typical image formation. The control use patterns thus formed are detected by a sensor thereby analog signals are obtained. The analog signals are then converted into digital signals. The digital signals then undergo prescribed processing, and are used to control the image forming apparatus. The control use patterns are then erased on the conveyance member.

Position control is a typically executed based on such control use patterns. The position control corrects deviation of a transfer position of each of colors when a plurality of color image formation engines are used. Because, even very small deviation causes deterioration of quality of an image. Then, position control use patterns are formed on a conveyance member moving at high speed, and are expected to be precisely detected and handled within a prescribed time period. However, a change in density of toner when the toner decreases and noises on a digital signal created during pattern detection affect precision of detection of such patterns.

Then, Japanese Patent Application Laid Open No. 2003-133143 discusses that patterns are formed on a conveyance member to detect toner density. A threshold value is determined based on the density when a digital signal created from the pattern is processed.

Further, Japanese Patent Registration No. 3640629 discusses that prescribed digital filtering processing is applied to a digital signal created from a detection pattern using a DSP (Digital signal processing), thereby noises overlying on the digital signal are removed.

However, these conventional technologies still need to be improved.

### SUMMARY OF THE INVENTION

The present invention has been made in view of the above noted and another problems and one object of the present invention is to provide a new and noble control circuits and image forming apparatus.

Such a new and noble control circuit and image forming apparatus executes controlling by using various types of patterns formed on a conveyance member. Such an image forming apparatus includes a conveyance member having first and second type patterns on the surface thereof. The first and second type patterns are a different shape from the other.

First and second pattern detection devices are provided to detect the first and second type patterns and output first and second analog signals, respectively. First and second A/D conversion devices are provided to convert the first and second analog signals into first and second digital signals, respectively. A first calculation execution device is provided to execute a first calculation for controlling the image forming apparatus using the first digital signal. A second calculation execution device is provided to execute a second calculation for controlling the image forming apparatus using the second digital signal. The first calculation execution device is realized by software while the second calculation operation execution device is realized by a hardware circuit.

An operation amount of the calculation executed by the first calculation execution device is less than that of the calculation executed by the second calculation execution device.

The controlling with the first digital includes process control.

The controlling with the second digital signal includes position control.

A pattern position calculation device is provided to calculate a position of an element of the second type pattern. The element includes a prescribed width in a sub scanning direction in parallel to a conveyance member conveying direction. The second pattern detection device executes detection at a prescribed position in a main scanning direction perpendicular to the conveyance member conveying direction, and the pattern position calculation device calculates one of leading, middle point, and trailing portions of the element based upon the second digital signal.

The pattern position calculation device executes product-summing calculation.

A control circuit includes a process control calculation device realized by software and executes calculation for process control of the image forming apparatus using a first digital signal. The first digital signal is generated by detecting a first type pattern formed on a conveyance member conveying a medium and converting a detection signal into a digital signal. A process control device is provided to execute process control for the image forming apparatus based on an output from the process control calculation device. A position calculation device includes a hardware circuit that executes calculation for position control using a second digital signal. The second digital signal is generated by detecting a second type pattern formed on the conveyance member in a different shape from the first type pattern and converting a detection signal into a digital signal. A position calculation control device is provided to control the position calculation device. A position control device is provided to control a position of an image based on an output from the position calculation device.

The control circuit and the position calculation device are sealed within a package.

### BRIEF DESCRIPTION OF DRAWINGS

A more complete appreciation of the present invention and many of the attendant advantages thereof will be readily obtained as the same becomes better understood by reference to the following detailed description when considered in connection with the accompanying drawings, wherein:

FIG. 1 illustrates an exemplary image formation unit and its periphery included in an image forming apparatus;

FIG. 2 illustrates an exemplary pattern formed on a conveyance member and an exemplary sensor unit provided for detecting the pattern;

FIG. 3 illustrates an exemplary control circuit included in the image forming apparatus according to one embodiment of the present invention;

FIG. 4 illustrates an exemplary calculation circuit that executes calculation according to one embodiment of the present invention; and

FIG. 5 illustrates an exemplary calculation operation sequence of position control according to one embodiment of the present invention.

### PREFERRED EMBODIMENTS OF THE PRESENT INVENTION

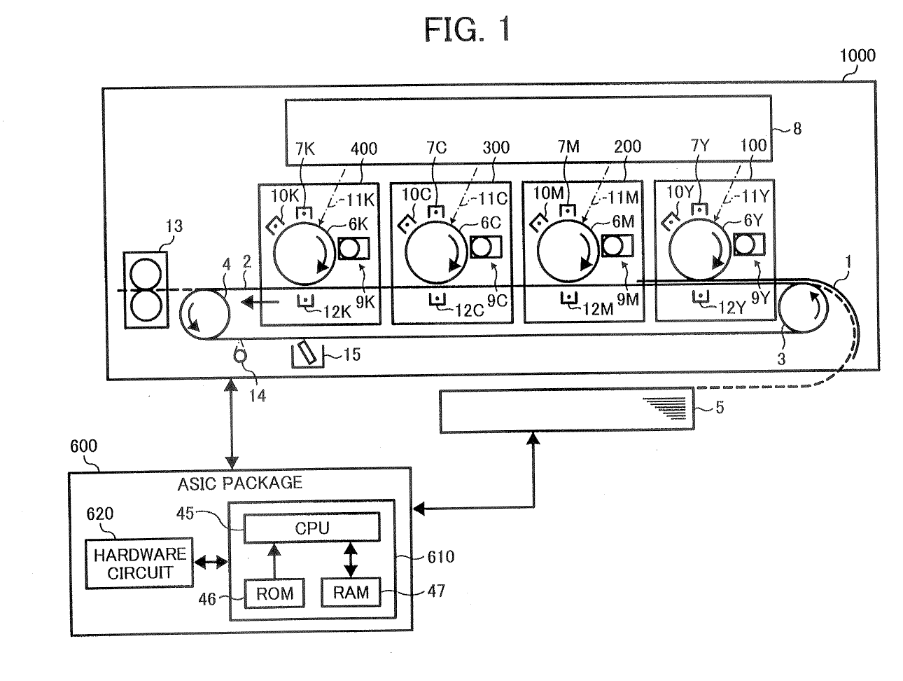

Referring now to the drawings, wherein like reference numerals and marks designate identical or corresponding parts throughout several figures, in particular in FIG. 1, an exemplary image formation engine of a color image forming apparatus and its periphery are illustrated.

The image forming apparatus includes an image formation engine 1000, an ASIC package 600, and a sheet feed tray 5.

The image formation engine 1000 forms an image on a medium such as a transfer sheet. The sheet feed tray 5 accommodates transfer sheets 1 on which the image formation engine 1000 forms an image. The ASIC package 600 controls each of sections of the image forming apparatus in addition to the image formation engine 1000 and the sheet feed tray 5.

The image formation engine 1000 includes yellow, magenta, cyan, and black image formation units 100, 200, 300, and 400.

The image formation engine 1000 also includes a conveyance member 2, an exposure device 8, a driving roller 3, a driven roller 4, a fixing device 13, a sensor unit 14, and a cleaning unit 15.

Yellow, magenta, cyan, and black image formation units 100, 200, 300, and 400 are provided to form yellow, magenta, cyan, and black images on a transfer sheet 1, respectively.

The conveyance member 2 is wound around the driving and driven rollers 3 and 4 driving and driven by the driving roller 3. Thus, the driving and driven rollers 3 and 4 cooperatively move the conveyance member 2 and convey the transfer sheet 1.

An exposure device 8 emits laser light in accordance with image data of respective colors. A fixing device 13 fixes toner adhered to the transfer sheet 1. A sensor unit 14 detects a control use pattern formed on the conveyance member 2. A cleaning unit 15 erases the control use pattern.

The yellow, magenta, cyan, and black image formation units 100 to 400 include photo-conductive members 6Y, 6M, 6C, and 6K, charging devices 7Y, 7M, 7C, and 7K, developing devices 9Y, 9M, 9C, and 9B, photo-conductive member cleaners 10Y, 10M, 10C, and 10B, and transfer devices 12Y, 12M, 12C, and 12B.

An ASIC package 600 includes a control circuit 610 and a hardware circuit 620. The control circuit 310 controls each section of the image forming apparatus and the hardware circuit, and executes calculation for process control. The control circuit 610 further includes a CPU 45, a ROM 46, and a RAM 47. The CPU 45 controls each section of the image forming apparatus and creates a signal for control use while executing program stored in the ROM 46. The hardware circuit 620 executes calculation for position control.

During image formation processing, the topmost transfer sheet among the transfer sheets 1 is attracted onto the conveyance member 2 by means of electrostatic absorption. When the driving roller 3 rotates in a direction shown by an arrow, the transfer sheet 1 passes through the respective image formation units.

When the discharge device 7Y discharges the photoconductive member 6Y and the exposure device emits a laser light 11Y in the yellow image formation unit 100, a latent image for a yellow image is formed. The developing device 9Y then adheres toner and executes development. The toner adhered to the photoconductive member 6Y is transferred onto a transfer sheet 1 by the transfer device 12Y while electric charge is applied from the transfer sheet side. When such a transferring process is completed, the cleaning device 10Y removes the toner and the electric charge each remaining on the photoconductive member 6Y.

When such processing is completed in each of the remaining magenta, cyan, and black image formation units 200 to 400 subsequent to the yellow image formation, respective color toner images are transferred and superimposed on the transfer sheet 1, and thereby a color image is formed.

The fixing device 13 fixes the toner onto the transfer sheet 1. A color image formation process is thereby completed.

In the image formation processing, process control of setting various image formation conditions as well as position control of adjusting a transfer position on a transfer sheet 1, on which the image formation unit executes transfer, are executed.

The process control sets various image formation conditions of the image formation processing. For example, an amount of electric charge applied to the photo-conductive members 6Y to 6K from the discharge devices 7y to 7K, intensity of exposure from the exposure device 8, density of toner adhered by the developing devices 9Y to 9K, and an amount of electronic charge applied from the transfer devices 12Y to 12K are controlled. Owing to fatigue of a photoconductive member or decrease in toner remaining amount, an optimal value for the image formation condition varies. Then, a pattern for process control use is directly formed on a conveyance member 2 using respective image formation units during the image formation process, and the sensor unit 14 detects density of the pattern, thereby data indicating conditions of sections of the respective color image formation units are obtained. Then, data used to control the section is obtained by comparing the condition indicating value with a reference value retained in the image forming apparatus.

Further, the position control is executed to adjust transfer positions on a transfer sheet 1, onto which respective image formation units 100 to 400 execute transfer, when a color image is formed. Deviation of the transfer position in each of the respective image formation units largely affects quality of an image. Thus, the transfer positions are necessarily precisely controlled and adjusted. Then, a pattern for position control use is directly formed on the conveyance member 2 for process control use. Then, the sensor unit 14 detects elements included in the pattern for the position control use.

Noise is removed to improve precision of calculation of these positions. By comparing a position value obtained by the calculation with a reference value retained in the image forming apparatus, relative positions of the respective image formation units 100 to 400 in relation to the conveyance member 2 at the respective transfer positions when the position control use pattern is detected is calculated. Then, control values for controlling the sections are obtained.

These patterns for process control and position control uses are formed by the respective color image formation units 100 to 400, and are detected by the sensor unit 14. Then, analog signals are transmitted to the ASIC package 600. The pattern detected by the sensor unit 14 is then cleaned and erased from the conveyance member 2 by a cleaning unit 15.

The image forming apparatus employs a direct transfer system in which the respective image formation units 100 to 400 directly form images on a medium such as a sheet conveyed on the conveyance member 2 as shown in FIG. 1. The present invention can be applied to an image forming apparatus including an intermediate transfer system, in which image formation units 100 to 400 transfer different mono color images onto the intermediate transfer member such as a intermediate transfer belt, a transfer drum, etc., and are thereby transferred onto a medium 1 such as a sheet. Thus, a conveyance member carrying patterns for control use represents a conveyance member when the direct transfer system is employed, and an intermediate transfer member when the intermediate transfer system is employed.

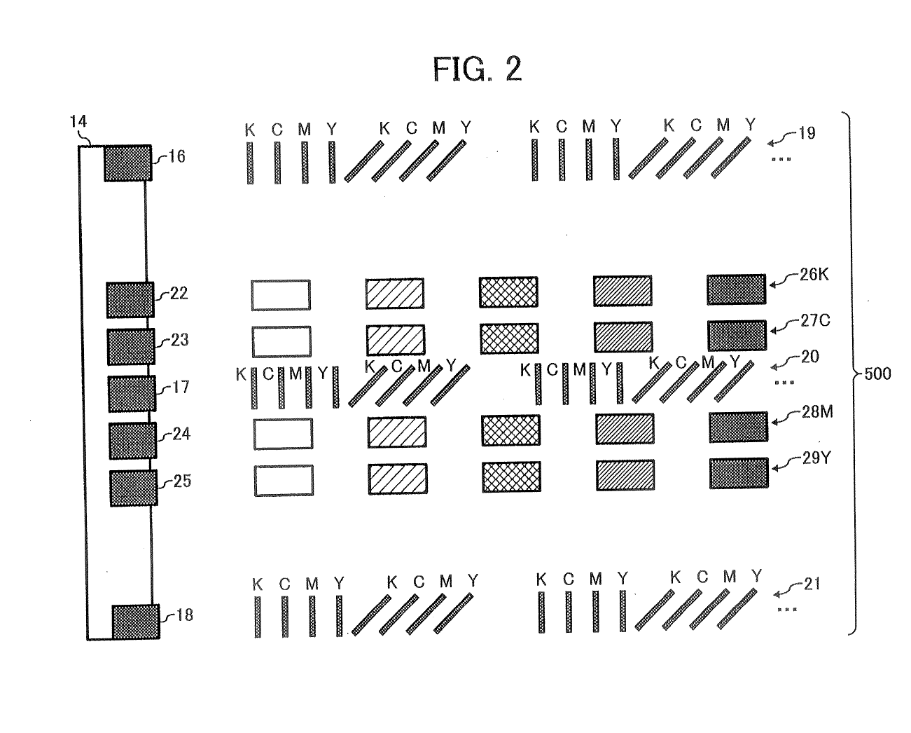

An exemplary pattern 500 for control use formed on a conveyance member 2 and an exemplary sensor unit 14 for detecting the pattern are now described with reference to FIG. 2.

The control use pattern 500 includes a first pattern 26 to 29, and a second pattern 19 to 21 each formed on the conveyance member avoiding overlap with the other.

The sensor unit 14 includes sensors 26 to 29 for detecting the first pattern, and sensors 16 to 18 for detecting the second pattern. Each of the sensors includes more than one sensing point to execute detection at a prescribed position in a main scanning direction of the conveyance member.

It is supposed in the below described several embodiments that a direction perpendicular to a conveying direction of the conveyance member represents the main scanning direction, and the conveyance member conveying direction represents a sub scanning direction.

The first patterns 26 to 29 are process control use and are used to create process control signals for forming black, cyan, magenta, and yellow images, respectively. The sensors 22 to 25 detect these patterns 26 to 29, respectively. The patterns 26 to 29 include a plurality of elements avoiding overlap from the other.

Density of a pattern for process control use is calculated by averaging voltages of digital signals generated based on outputs from the sensors 22 to 25 in a time axis direction to be used when calculation for process control is executed. The size of elements of the patterns 26 to 29 is large enough in relation to a time period needed to detect these densities. An amount of calculation to obtain the average of the voltages is small enough in relation to an amount of processing executed by a CPU 45. Thus, these operations can be executed by the CPU 45 using prescribed software rather than a hardware circuit 620 that is necessarily private use.

The second patterns 19 to 21 are for position control use. These patterns 19 and 21 are formed in the vicinity of both ends of the conveyance member, while the pattern 20 is formed in the vicinity of the widthwise center of the conveyance member. The sensors 16 to 18 detect the patterns 19 to 21, respectively.

Elements collectively forming the position control use pattern are formed by the respective color image formation units not to overlap with the other, in parallel and slanting in relation to the main scanning direction. The calculation of position control includes the steps of detecting an edge of each of the elements, calculating a distance between the respective elements at the edge positions, and comparing the calculated distance with a reference value retained in the image forming apparatus.

Herein below, a start point of an element of a pattern in a sub scanning direction is referred to as an edge start point, an end point thereof in the sub scanning direction is referred to as an edge end point, and edge start and end points are referred to as edges when detection executed at a fixed point in the main scanning direction is described.

For example, when a black element is supposed to be a reference color among elements extending in parallel to the main scanning direction in the pattern 19, a deviation in the sub scanning direction of a transfer position, onto which the respective color image formation units transfer, can be calculated in relation to that the black image formation unit transfers while calculating a distance between the reference color and respective color elements and comparing the calculation result with the above-mentioned reference value.

Also, using the pattern 19, a deviation in the main scanning direction of the transfer position, onto which a color image formation unit transfers, can be calculated by calculating a distance between an element of a prescribed color extending in parallel to the main scanning direction and that inclining thereto, and then comparing the calculation result with the above-mentioned reference value. For example, when the calculated distance is larger than the reference value, the transfer position for the prescribed color image formation unit is below the reference position in FIG. 2.

Further, the patterns 19 to 21 are formed in the vicinity of both sides and a widthwise center of the conveyance member. Then, by calculating relative positions of prescribed color elements of a pattern in relation to the pattern 19 as a reference, a deviation in the main scanning direction can be calculated.

Since position control is to be expected to be highly precise, respective positions of elements of patterns 19 to 21 need to be precisely calculated. Then, a digital signal generated from the second pattern preferably undergoes noise removal. A noise signal is included in a digital signal when stein appears on the conveyance member 2 or something is included in an analog signal during pattern detection, for example. Since these noise signals frequently appear in a high frequency region rather than an edge, the noise signal can be removed by applying digital filtering to the digital signal using a lowpass filter. Since such a process of the lowpass filter includes product-summing calculation and thereby necessitates a large operation amount, a private use hardware circuit 620 is preferably used to deal therewith.

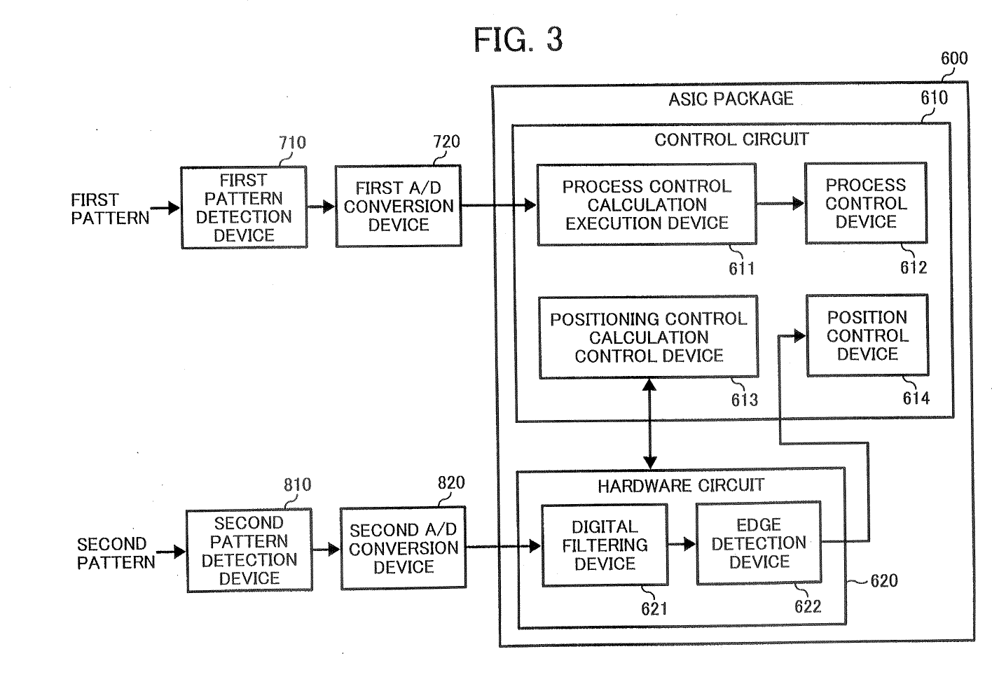

An exemplary image forming apparatus according to the present invention is now described with reference to FIG. 3.

First and second A/D conversion devices 720 and 820 are connected to an ASIC package 600. First and second detection devices 710 and 810 are connected to the first and second A/D conversion devices 720 and 820, respectively.

The ASIC package 600 is formed by sealing a control circuit 610 and a hardware circuit 620 in a one-chip.

The control circuit 610 is realized by software and executes various operations when a CPU 45 runs program stored in the ROM 46. The control circuit 610 controls various sections of the image forming apparatus and executes calculation for process control in accordance with program stored in the ROM 46.

The hardware circuit 620 is private use that calculates positions of respective elements in a pattern.

The control circuit 610 further includes a process control calculation execution device 611, a process control device 612, a position control calculation control device 613, and a position control device 614. The hardware circuit 620 includes a digital filter processing device 621 and an edge detection device 622.

The first pattern detection device 710 detects a first type pattern and outputs an analog signal to the first A/D conversion device 720. The first A/D conversion device 720 converts an analog signal into a digital signal. The process control calculation execution device 611 calculates an average of voltages based on digital signals created from the first type pattern, which is outputted by the first A/D conversion device 720, thereby calculating density of elements of the first type pattern. Then, by comparing the density value with a reference value retained in the image forming apparatus, calculation for process control is executed. The process control device 612 executes process control in each of units of the image forming apparatus in accordance with an output from the process control calculation execution device.

The second pattern detection device 810 detects a second type pattern and outputs an analog signal to the second A/D conversion device 820. The second A/D conversion device 820 converts an analog signal into a digital signal. The digital filter processing device 621 executes digital filter processing including product-summing in order to remove noises on a digital signal created from the second type pattern and outputted by the second A/D conversion device. The edge detection device 622 calculates edge positions of elements of the pattern based on the digital signal without noise with reference to a threshold value of a voltage set by the position control calculation control device 613.

The position control calculation control device 613 reads and transmits data from a register, not shown, to the hardware circuit 620, and stores data received from the hardware circuit 620 in the register, thereby controlling the digital filter processing device 621 to execute product-summing. The position control calculation control device 613 transmits a threshold value of a voltage to the edge detection device 622 to be used in calculating edge positions. The position control device 614 calculates positions, where respective images are formed, based on an output of the hardware circuit 620, there by executing position control.

An exemplary control circuit included in the image forming apparatus according to the present invention is now described.

An analog signal outputted from each of the sensors 16 to 18 and 22 to 25 is inputted to the ASIC package 600. The ASIC package 600 processes the analog signal, executes calculation for process control and position control, and executes these process control and position control.

The ASIC package 600 includes an I/O, an I/F 30, multiplexors 31 and 35, A/D conversion devices 32 and 36, control circuits 33 and 37, a de-multiplexor 38, lowpass filter processing circuits 39 to 41, edge detection circuits 42 to 44, a register 34, a CPU 45, a ROM 46, a RAM 47, an address 48, and a data bus 49.

The I/O and the I/F 30 of an ASIC package 600 collectively serves as an input/output interface for a signal. The multiplexor 31 multiplexes analog signals outputted from the sensors 22 to 25. The A/D conversion device 32 converts an analog signal of an output from the multiplexor into a digital signal. The control circuit 33 controls the multiplexor 31 and the A/D conversion device 32.

The multiplexor 35 multiplexes analog signals outputted from the sensors 15 to 19. The A/D conversion device 36 converts an analog signal of an output from the multiplexor 35 into a digital signal. A de-multiplexor 38 distributes the digital signal outputted from the A/D conversion device 36 into signals corresponding to the sensors 15 to 19. The control circuit 37 controls the multiplexor 35 and the de-multiplexor 38.

Each of lowpass filters 39 to 41 removes noises by applying lowpass filter processing, such as product-summing, etc., to the digital signal that is inputted. Each of edge detection circuits 42 to 44 detects edges of a pattern based on the digital signal that is inputted.

The register 34 stores and reads values created by respective circuits. The CPU 45 controls respective sections of the image forming apparatus, and executes calculation for such controlling. The ROM stores program to be executed by a CPU. The RAM 47 stores temporary data to be used by a CPU.

Now, creation of a process control signal is described. Analog signals are created from the process control use patterns 26 to 29, outputted from the sensors 22 to 25, and multiplexed by the multiplexor 31. Then, the analog signals are converted into digital signals by the A/D conversion device 32 and are stored in the register 34. The CPU 45 calculates density of each of elements of a process control use pattern 26 to 29 by calculating an average of voltages generated from the patterns with reference to the value retained in the register. The CPU 45 executes calculation for process control by comparing the calculated value with a reference value retained in the image forming apparatus.

Creation of a position control signal is now described. Analog signals created from the position control signal use pattern as outputs of the sensor 18 are multiplexed by the multiplexor 35, and are converted into a digital signal by the A/D conversion device 36. The analog signal is distributed as signals of the sensors in the de-multiplexor 38. When respective digital signals obtained from patterns 19, 20, and 21 are processed by combinations of the low pass filter processing circuit 39 and the edge detection circuit 42, those of 40 and 43, and 41 and 44, respective positions of elements of a position control use pattern and distances between the elements are calculated. The position control is executed in accordance with a result of comparison of the calculated element distance and position with reference values retained in the image forming apparatus, respectively.

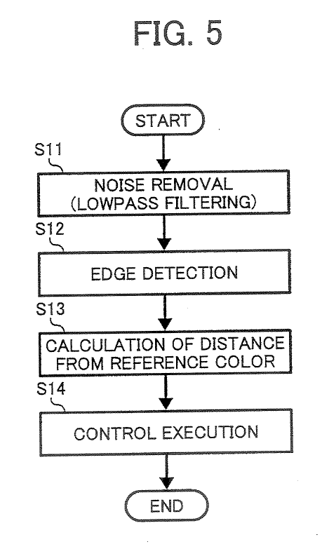

Now, processing of a digital signal obtained from a pattern 16 is described with reference to FIG. 5, which illustrates a calculation sequence of position control.

As shown, in step S11, the lowpass filter processing circuit 39 removes noises by means of lowpass filter processing. Since this calculation operation includes product summing, the calculation result is temporarily retained in the register 34, and utilized in the next calculation again.

In step S12, the edge detection device 2 detects an edge of an element of a pattern 19 by comparing a digital signal of an output of the lowpass filter processing device 39 with a prescribed threshold. Such a prescribed threshold is obtained by detecting density of toner of a pattern, and is transmitted to the edge detection device by the CPU 45.

In step S13, the CPU 45 calculates a distance between elements of a pattern 19 based on the outputs of the edge detection device 42. Specifically, a distance between an element of a reference color, such as a black, etc., and the other color element is calculated. Further, among elements of the pattern 19, a distance between an element of the color arranged perpendicular to a conveyance direction of the conveyance member and that diagonally arranged in relation thereto is calculated.

In step S14, the CPU 45 executes position control based on a distance calculated in step S13.

The digital signals transmitted from the sensors 17 and 18 are processed by the lowpass filter processing circuits 40 and 41, and edge detection circuits 43 and 44, respectively.

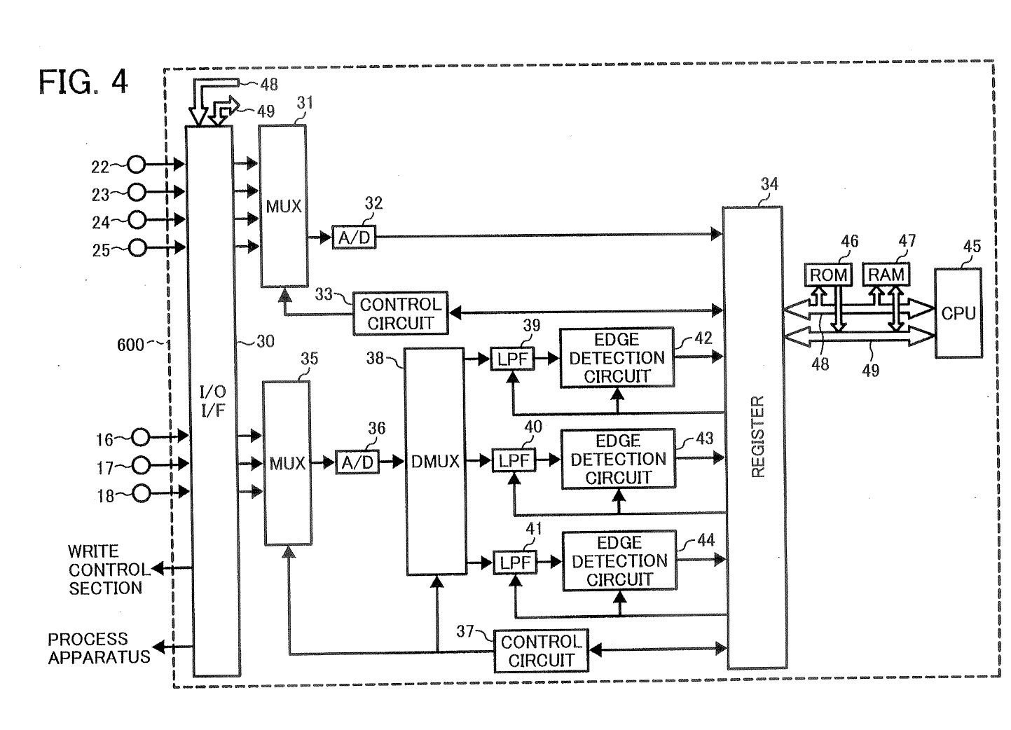

Back to FIG. 4, the lowpass filter processing is executed to remove noises of the digital signal. However, prescribed digital filtering processing, such as IIR (Infinite impulse response), FIR (Finite impulse response), etc., can be employed for the lowpass filter processing. Although the above-mentioned image forming apparatus is described using the direct transfer system, in which respective color image formation units directly transfer images onto a medium, such as a sheet, etc., carried on the conveyance member, the present invention can be applied to an intermediate transfer system including a conveyance belt or a transfer drum or the like serving as an intermediate transfer member.

Although the ASIC package 600 includes the multiplexers 31 and 35, the A/D conversion circuits 32 and 36, and a de-multiplexer 38 as shown in FIG. 4, these circuits can be omitted.

Although the lowpass filter circuits 39 to 41 and the edge detection circuits 42 to 44 are included corresponding to the sensors 16 to 18, respectively, as shown in FIG. 4, they can be constituted by only a unit of a lowpass filter circuit and an edge detection circuit.

Further, also the CPU calculates a distance and an angle between elements of respective patterns as shown in FIG. 4, a private use hardware circuit can be employed.

Obviously, numerous additional modifications and variations of the present invention are possible in light of the above teachings. It is therefore to be understood that within the scope of the appended claims, the present invention may be practiced otherwise than as specifically described herein.

What is claimed is:

1. An image forming apparatus, comprising:
a conveyance member having first and second type patterns thereon, said first and second type patterns being a different shape from the other;
a first pattern detection device configured to detect the first type pattern and output a first analog signal;
a second pattern detection device configured to detect the second type pattern and output a second analog signal;
a first A/D conversion device configured to convert the first analog signal into a first digital signal;
a second A/D conversion device configured to convert the second analog signal into a second digital signal;
a first calculation execution device configured to execute a first calculation for controlling the image forming apparatus using the first digital signal;
a second calculation execution device configured to execute a second calculation for controlling the image forming apparatus using the second digital signal;
wherein said first calculation execution device is realized by software, and the second calculation operation execution device is realized by a hardware circuit.

2. The image forming apparatus as claimed in claim 1, wherein an operation amount of the calculation executed by the first calculation execution device is less than that of the calculation executed by the second calculation execution device.

3. The image forming apparatus as claimed in claim 1, wherein said controlling with the first digital signal includes process control.

4. The image forming apparatus as claimed in claim 1, wherein said controlling with the second digital signal includes position control.

5. The image forming apparatus as claimed in claim 4, further comprising:
a pattern position calculation device configured to calculate a position of an element of the second type pattern, said element including a prescribed width in a sub scanning direction in parallel to a conveyance member conveying direction;
wherein said second pattern detection device executes detection at a prescribed position in a main scanning direction perpendicular to the conveyance member conveying direction, and
wherein said pattern position calculation device calculates one of leading, middle point, and trailing portions of the element based upon the second digital signal.

6. The image forming apparatus as claimed in claim 5, wherein said pattern position calculation device executes product-summing calculation.

7. A control circuit, comprising:
a process control calculation device realized by software and configured to execute calculation for process control of the image forming apparatus using a first digital signal, said first digital signal being generated by detecting a first type pattern formed on a conveyance member conveying a medium and converting a detection signal into a digital signal;
a process control device configured to execute process control for the image forming apparatus based on an output from the process control calculation device;
a position calculation device including a hardware circuit configured to execute calculation for position control using a second digital signal, said second digital signal being generated by detecting a second type pattern formed on the conveyance member in a different shape from the first type pattern and converting a detection signal into a digital signal;
a position calculation control device configured to control the position calculation device; and
a position control device configured to control a position of an image based on an output from the position calculation device.

8. The control circuit as claimed in claim 7, wherein said control circuit and the position calculation device are sealed within a package.
